(19) United States
(12) Patent Application Publication
(10) Pub. No.: US 2021/0129507 A1
(43) Pub. Date: May 6, 2021

(54) COMPOSITE BODY

(71) Applicant: Senosan GmbH, Piesendorf (AT)

(72) Inventor: Wilhelm Klepsch, Kaprun (AT)

(21) Appl. No.: 17/099,009

(22) Filed: Nov. 16, 2020

Related U.S. Application Data
(62) Division of application No. 14/342,181, filed on Apr. 17, 2015.

(30) Foreign Application Priority Data
Sep. 1, 2011 (EP) 11179746.0

(51) Int. Cl. B32B 27/08; B32B 27/36; B32B 27/30; B29C 63/04; B32B 33/00; B32B 27/18; B32B 27/20; B32B 37/14

(52) U.S. Cl. CPC B32B 27/08; B32B 2038/0076; B32B 27/302; B32B 27/30; B29C 63/044; B32B 33/00; B32B 27/18; B32B 27/20; B32B 27/308; B32B 37/14; B32B 2307/406; B32B 2307/554; B32B 2307/584; B32B 2479/00; B32B 2250/24; B32B 2255/10; B32B 2255/26; B32B 2310/0831; B32B 27/36

(57) ABSTRACT

A multi-layered composite body, having an UV-cured cover layer (1) forming the surface and having a layer thickness of 1-20 μm, which has the following characteristics: a) a gloss loss of at most 30%, preferably at most 20% following a micro-scratch resistance test measured following prEN 16094 (as of 2010 May 15: “Laminate floor coverings—Test method for the determination of micro-scratch resistance”), b) a numerical assessment of ≥3, in a chemical resistance test measured according to DIN EN 12720 (as of July 2009: “Furniture—Assessment of surface resistance to cold liquids”) using acetone as a test liquid for a test duration of 1 h, c) a gloss of at least 80, preferably at least 85 GLE measured according to ISO 2813 (as of 1999 Jun. 1: “Coating materials—Determination of the reflectometer value of coatings at 20°, 600 and 85°”) at an observation angle of 20° and d) a haze of at most 20, preferably at most 15, measured according to ISO 13803 (as of 2004 Sep. 1: “Coating materials—Determination of reflection haze of coatings at 20°); a bending device for the composite body

### RELATED APPLICATION

This application is a divisional application of U.S. Non-Provisional application Ser. No. 14/342,181, filed Apr. 17, 2015, which is based upon and claims priority to PCT/EP2012/067038, filed Aug. 31, 2012. Priority is hereby claimed under 35 U.S.C. § 120 to U.S. Non-Provisional application Ser. No. 14/342,181 and to International Application No. PCT/EP2012/067038, both of which the entire specifications are hereby expressly incorporated by reference.

### BACKGROUND

The invention relates to a method for the production of multi-layered composite bodies having improved optical and physico-chemical surface characteristics as well as the multi-layered composite bodies resulting from the method and the use thereof, in particular as a furniture foil and for pieces of furniture. The invention further relates to a bending device for such composite bodies as well as to a forming shoe for a bending device.

The requirements for high-gloss furniture surfaces are comprehensive and varied: apart from optical characteristics, also scratch and abrasion resistance as well as resistance to certain chemicals play an important role. Increasingly, also ecological requirements have become an issue: large areas are to be surface-coated, thus leading to ecology-relevant topics such as solvent emission of the surface-coating materials, overspray and the like. Based on these findings, the surface-coating of furniture fronts has been substituted for lamination of coloured, scratch-resistant, high-gloss films onto carriers such as MDF (medium-density fibreboard) panels. One reason therefore was the costs associated with the surface-coating process, which may be realized significantly more cost-effective using film technology. In the field of films, there are existent different layer configurations, composed of different polymers, which are, for the most part, coated scratch-resistant using surface-coating materials. In part, these are produced using co-extrusion methods, wherein a layer of a scratch-resistant polymer, in general polymethyl methacrylate, is extruded thereon as a thin layer. Films based on surface-coating materials usually show good performance with regard to scratch-resistance as well as resistance to chemicals, whereas co-extruded multi-layered composite bodies show advantages due to process-conditioned excellent optical surface characteristics such as gloss, haze and uniformity.

In addition, also glass has proven to be useful as a material. The rear side of which is printed using the preferred colour and further processed. Printed glass panels combine the optical characteristics of the co-extruded films as well as the physical characteristics, which are posed to surfaces in the field of furniture, to a very high extent. In particular, the glass surfaces show excellent characteristics with regard to micro-scratch resistance measured according to prEN 16094 (as of 2009 Nov. 1) as well as with regard to resistance to chemicals measured according to DIN EN 12720 (as of July 2009). It has, however, been known that glass panels have a high weight per unit area and are thus difficult to process.

WO 00/63015 A1 describes the use of a composite layer foil or panel, respectively, for coating form parts, wherein this foil consists of a substrate and a radiation-curable cover layer. Curing using radiation is realized following deep-drawing of the foil. The cover layer is transparent. A colouring intermediate layer may be introduced. In-between the cover layer and the colouring intermediate layer there may be provided a layer of PMMA or other thermoplasts. The disadvantage of this foil is that it is cured only after the processing step (thermoforming). Non-cured, this is curable surface-coating layers are very sensitive to mechanical damage, as the surface-coating material is not yet cross-linked and, hence, prone to scratches, which leads to major drawbacks in the further processing of the foil, e.g., in lamination. By contact pressing the foils onto the MDF panel by way of rollers, there is applied high pressure to the sensitive, non-cured surface-coating layer, with micro-contaminations engraving into the non-cured surface-coating layer. This will not be accepted by customers. If surface-coating systems of this type, however, are cured, there will be existent further disadvantages in the use for furniture, as these, in general, cannot be expanded any further, they cannot be stretched.

WO 2009/024310 A2 describes a surface-coating material, which is cured or partly cured and applied, at least in parts, onto a substrate. The configuration may be mono- or multi-layered and consists of thermoplasts, among others ABS and/or PMMA. The carrier has a thickness of 10-1500 um. The thickness of the surface-coating material is 15-80 um after being completely cured. In-between the layer of the surface-coating material and the carrier layer there may be existent a colouring or effect colouring layer. There is described that the surface-coating system on carrier foils is also suitable for being used in the field of furniture and that this has an ultimate elongation of 50-80%, which is why it may be bent, stretched or stretch-bent. For this reason, however, the surface also shows reduced abrasive characteristics: the micro-scratch resistance known from glass cannot be achieved using these surface-coating systems.

WO 02/90109 A1 describes a multi-layered furniture film, which fulfils certain tensile characteristics at elevated temperatures. Foil configurations of this type do indeed show optically good surface characteristics, they are, however, rather prone to scratches due to their high ultimate elongation. These foils are predominantly processed by way of thermal forming procedures such as membrane pressing, and they show good bending and stretch performance. They have, however, a serious lack of micro-scratch resistance measured according to prEN 16094 (as of 2009 Nov. 12) as well as resistance to chemicals measured according to DIN 68861-1 (as of April 2001), classification according to grade 5 in class A1.

WO 2011/012294 A1 describes a method, in which an at least mono-layered substrate is coated with at least one protective layer in-line in the extrusion, wherein the protective layer is photochemically cured by electromagnetic irradiation. The substrate layer is non-coloured, and it is produced by means of (co)-extrusion. When the protective layer is applied, the substrate has a temperature of 60-90° C. The substrate may include PMMA, PC and PET.

WO 2005/042248 A1 describes a multi-layered composite body having a PMMA cover layer, onto which a layer of surface-coating material is printed. The surface-coating material may be based on solvents; it may be UV-curing or it may be produced on the basis of water. The layer thickness is 1-50 !AM, it need not be applied on the entire surface, and it may include colorants or matting agents. The composite body may be thermoformed. Printed semi-finished products of this type offer possibilities for decorating surfaces, wherein the surface is completely printed and may be partially removed again afterwards by way of laser or engraving techniques. The alternative is partial printing.

From prior art there is not known a composite body, which—to a sufficient extent—fulfils all requirements regarding optical and mechanical characteristics and simultaneous low weight per unit area and high resistance to chemicals in order to being permanently used in the furniture industry—especially in heavily stressed and strained areas.

### BRIEF SUMMARY OF THE INVENTION

Hence, it is the task of the present invention to provide a composite body, which may be used instead of surface-coating materials and glass having the following characteristics:
The micro-scratch resistance and the resistance to chemicals should be rather high in comparison with conventional composite bodies.
The surface should have good optical characteristics, similar to those of glass.
The composite body should be free of halogens.
The composite body should be colourable in any colour according to the customer's wishes.
The composite body should be formable.
The surface colouring systems used must be free of solvents in order to meet the increasing ecological requirements.

The task is solved by a composite body, including in the order mentioned:
(i) a UV-cured cover layer (1) forming the surface and having a layer thickness of 1-20 vim,
(ii) optionally an upper intermediate layer (2) arranged underneath the cover layer (1),
( ) a lower intermediate layer (3-1), containing colorants and optionally additives for improving UV resistance,
(i) a substrate layer (3), containing a thermoplastic polymer or a blend of thermoplastic polymers, colorants as well as optionally grinding material, recyclate or regenerate,
(v) optionally an optional rear cover (3-2),
   (vi) optionally an adhesion promoter layer (4), which is characterized in that the surface has the following features:
a) a gloss loss of at most 30%, preferably at most 20% following a micro-scratch resistance test measured in accordance with prEN 16094 (as of 2010 May 15: “Laminate floor coverings
   Test method for the determination of micro-scratch resistance” (“Laminatboden-Priifverfahren zur Bestimmung der Mikrokratzbestandigkeit”)),
   b) a numerical assessment of >3, in a chemical resistance test measured according to DIN EN 12720 (as of July 2009: “Furniture—Assessment of surface resistance to cold liquids” (“Mobel-Bewertung der Bestandigkeit von Oberflachen gegen kalte Fliissigkeiten”)) using acetone as a test liquid for a test duration of 1 h,
   c) a gloss of at least 80, preferably at least 85 GLE measured according to ISO 2813 (as of 1999 Jun. 1: “Coating materials—Determination of the reflectometer value of coatings at 20°, 60° and 85°” (“Beschichtungsstoffe—Bestimmung des Reflektometerwertes von Beschichtungen unter 20°, 60 and 85°”) at an observation angle of 20° and
   d) a haze of at most 20, preferably at most 15, measured according to ISO 13803 (as of 2004 Sep. 1: “Coating materials—Determination of the haze of coatings at 20°” (“Beschichtungsstoffe—Bestimmung des Glanzschleiers von Beschichtungen bei 20°”)).

### BRIEF DESCRIPTION OF THE DRAWINGS

FIG. 1 shows a layer configuration having a cover layer (1), an upper intermediate layer (2), a lower intermediate layer (3-1), a substrate layer (3), a rear cover (3-2) and an adhesion promoter layer (4).

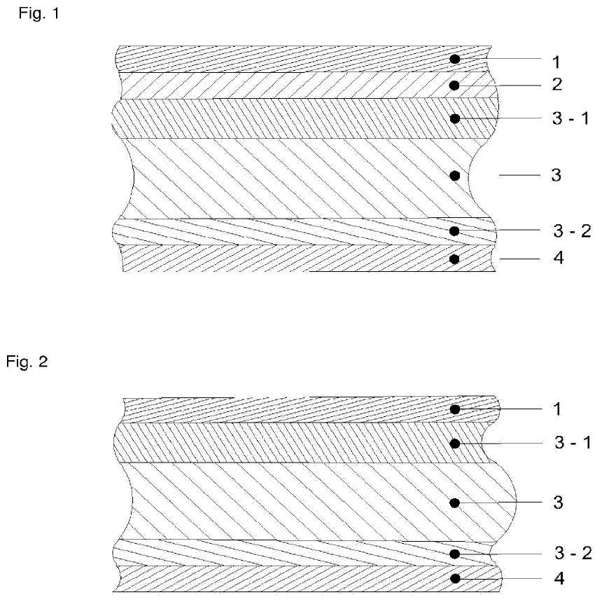

FIG. 2 shows a layer configuration having a cover layer (1), a lower intermediate layer (3-1), a substrate layer (3), a rear cover (3-2) and an adhesion promoter layer (4).

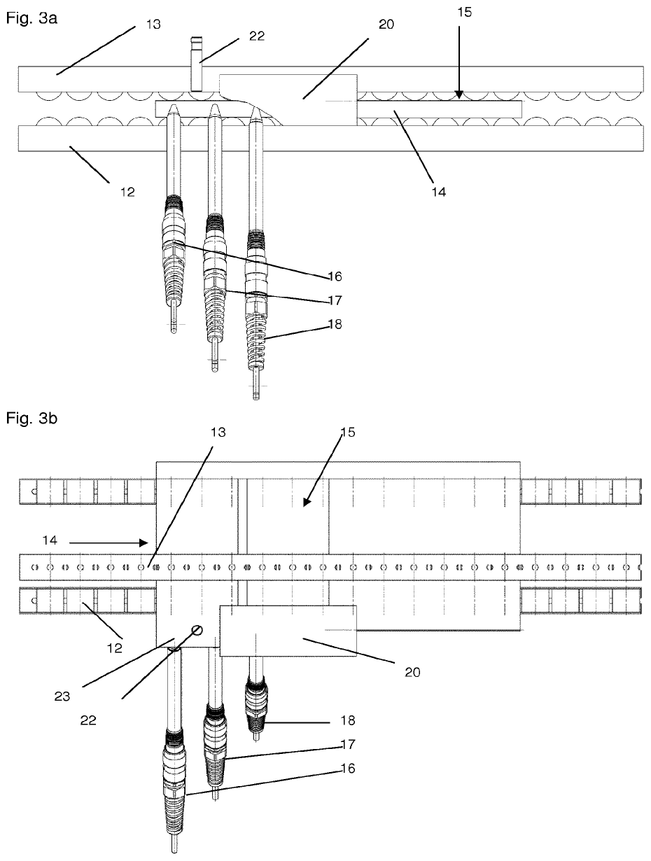

FIGS. 3a to 3d show a bending device in a side view (FIG. 3a), in a top view (FIG. 3b), from behind (FIG. 3c) and in a perspective view (FIG. 3d).

FIGS. 4a to 4f show detailed views of this bending device along the sectional planes depicted in FIG. 4a. Sectional plane A-A: FIG. 4b; B-B: FIG. 4c; C-C: FIG. 4d; D-D: FIG. 4e; E-E: FIG. 4f.

FIGS. 5a to 5d show a forming shoe for a bending device according to FIGS. 3a to 4f in different views.

### DETAILED DESCRIPTION OF THE DRAWINGS AND THE PRESENTLY PREFERRED EMBODIMENTS

It has been found that such multi-layered composite bodies according to the invention combine optical as well as mechanical, physical and physico-chemical characteristics, which meet the requirements needed in the furniture industry.

The initially posed problem is furthermore solved by a method for the production of a composite body, which is characterized in that a UV-curing, surface-coating material forming the cover layer and being free of any solvents is applied onto a UV-transparent transfer medium, wherein the UV-curing, surface-coating material is contact-pressed with the transfer medium onto the upper or the lower intermediate layer and consequently cured by exposure of the surface-coating material to UV radiation, wherein the UV irradiation is realized through the UV-transparent transfer medium.

There may be preferably provided that the UV irradiation is realized with simultaneous application of pressure.

There may be further provided that the UV irradiation is realized in several steps, wherein at least the first irradiation is realized through the transfer medium.

In one embodiment variant there is made the provision that a protective film is applied onto the cover layer following UV irradiation.

As a UV-transparent transfer medium there is understood a medium, which has a transmission for UV radiation, which is sufficient so that the polymerization of the UV-curable, surface-coating material is carried out. The choice of the material is dependent, on the one side, on the wavelength, which the UV-curable, surface-coating material needs for curing, and, on the other side, on the amount of UV radiation required. Depending on the selection of the UV-curable, surface-coating material, the expert skilled in the art may select a suitable medium.

It has been shown that the optical characteristics the UV-transparent and optically flawless transfer medium has were transferred upon curing onto the surface of the cover lay in a more or less identical way, so that the surface of the transfer medium has preferably the optical characteristics (gloss and haze) according to the claims.

Preferred embodiments and embodiment variants of the method according to the invention but also of the composite body according to the invention are described below.

Coating method There are known numerous methods for applying coatings. There are to be mentioned spreading, rolling, spraying, flooding, pouring, blade coating, tumbling, puttying and roller coating. The description of the individual methods is to be found in the book Goldschmidt-Streitberger, “BASF—Handbuch Lackiertechnik”, Vincentz-Verlag, edition 2002. The conventional methods used for the production of furniture films are spraying, pouring, blade coating and roller coating. By means of these methods, the surface-coating systems, which usually contain organic solvents or water or both, are applied. The solvents are usually flashed off following the coating process in drying chambers, which is why there is a high demand for energy and space. Furthermore, the surface-coating systems on the basis of organic solvents require high additional investments with regard to systems engineering, such as the installation of explosion protection or appropriate filter systems for absorbing the volatile organic ingredients of the surface-coating material. In addition, volatile organic ingredients are harmful from an ecological point of view, as these contribute to the greenhouse effect. For ecological and economical reasons it was thus the aim of this invention to at least attempt to prevent the use of surface-coating materials on an organic basis. The solution thereto is the use of solvent-free and UV-curing surface-coating systems.

Solvent-free and, hence, ecologically friendly UV-curing surface-coating systems, however, show high viscosities, which is why they are not, on the one side, suitable for some of the coating methods mentioned, and, on the other side, are prone to undesired surface structures (waviness, orange peel, hammer effect) due to the bad levelling characteristics conditioned thereby. For this reason, they may be excluded for the subject invention, as a glass-like optical surface characteristic cannot be achieved. Even more seriously, there is to be noted that surface-coating systems in general decrease upon cross-linking of the polymer chains, this leading to a surface optics not comparable with that of glass. The results of application resulting from the methods mentioned above were not satisfying in consideration of the surface irregularities. See also table 2 (“survey of the optical characteristics of coated surfaces in the field of furniture”). “Surface irregularities” is the term for optical surface structures, which have negative effects on uniformity. These are also known as waviness, orange peel or hammer effect. Apart from these physical parameters, gloss and haze are used as further characterizing aspects. These parameters may be characterized by measurement methods. Theoretical basics concerning optical characteristics are to be found in the publication Goldschmidt-Streitberger, “BASF—Handbuch Lackiertechnik”, Vincentz-Verlag, edition 2002, p. 363-372.

Characterization of Visual Observation: Waviness, Orange Peel, Hammer Effect

In order to characterize optical features like gloss, haze and waviness there have been developed methods for measuring the surface structures by means of laser beams. These are the determination of the reflexion that changes when the structured surface is scanned. By way of these measurement methods, a geometrical description of the surface structures is to provide the interdependencies for subjective perception.

The Wave Scan device (measurement device Wave-Scan Dual® by BYK-Gardner GmbH, Lausitzer StraBe 8, 82538 Geretsried) reproduces visual observation and analyses the surface structures with regard to their size. The method is described in detail in DE 103 39 227 Al, wherein there is also made reference to DE 41 27 215 A1 for a better understanding. In order to characterize the measurement device Wave-Scan Dual® there is referred to DE 10 2004 037 040 A1. The method conditions may be deduced from DE 103 39 227 Al so that herein there is made reference to these and the two other publications and so that there is referred to the explanations given therein. In DE 103 39 227 A1 there are mentioned five wavelength ranges Wa, Wb, Wc, Wd and We for filtering. In order to take into account the resolution performance of the eye at different distances, the optical profile is divided into these portions. Thereby, short wave and long wave approximately correspond to the ranges Wb and Wd, this is wavelengths from 0.3 to 1.2 mm for short wave and 1.2 to 12 mm for long wave. A survey of the wavelength ranges is given in table 1.

TABLE 1
Classification of wavelength ranges for optical surface assessment

| | Wa | Wb | We | Wd | We |
|---|---|---|---|---|---|
| Wavelength [mm] | 0.1-0.3 | 0.3-1.0 | 1.03-3.0 | 3.0-10 | 10-30 |

Characterization of Visual Observation: Gloss and Haze

Gloss is the characteristic of a surface to completely or partially reflect light. Gloss will only be developed if the illumination is bundled as well as if light is reflected mirror-like from the surface. Surface structures have effects on the gloss of a surface. This may be quantitatively determined using gloss measuring devices. The exact definition as well as the physical relations are defined in the ONORM EN ISO 2813; as of 1999 Jun. 1: “Coating materials Determination of the reflector value of coatings at 20°, 60 and 85°” (“Beschichtungsstoffe-Bestimmung des Reflektometerwertes von Beschichtungen unter 20°, 60° and 85°”). As a measuring device there is used for the tests the device: Haze Gloss, serial number: 868941 (manufacturer: Byk Gardner GmbH, 82538 Geretsried, Germany). As measuring geometry there is used the reflectometer value at 20°:

Haze or haze gloss is a special feature of gloss. It is caused by surface-near interferences in the range of 0.01 mm—also in the wavelength range of light. The exact definition of haze as well as the physical relations are described in the ONORM EN ISO 13803; as of 2004-0901: “Coating materials—Determination of the haze of coatings at 20°” (“Beschichtungsstoffe-Bestimmung des Glanzschleiers von Beschichtungen bei 20°”). As a measuring device there is used for the tests the device Haze Gloss, serial number: 868941 (manufacturer: Byk Gardner GmbH, 82538 Geretsried, Germany).

Table 2 shows a survey of the measurement results of optical characteristics of glass as a starting point of development, of ABS-PMMA co-extrudates, of different surface-coated surfaces, produced in the most common methods being in use in the furniture industry as well as composite bodies according to the invention.

As can be seen from table 2, glass shows extraordinary optical surface characteristics. This is also true for PMMA-ABS, however, showing already deficits regarding gloss and haze gloss. Films having surface-coated surfaces according to common coating methods (as in the columns P4 to P9) show defects in comparison with glass or PMMA-ABS, respectively.

TABLE 2
Survey of the optical characteristics of surface-coated surfaces in the field of furniture,

| | | | UV | | | roller | | | |
|---|---|---|---|---|---|---|---|---|---|
| | | | curedlacquer | roller coated | rollercoated | coatedwith | spray | | |
| | | | appliedacc, | 100%-UV cured | 100%- | electron | surface | | blade |
| | glass | PMMA-ABS | tothe invention | lacquer | solventlacquer | beam curing | coating | Flooding | coating |
| parameter | P1 | P2 | P3 | P4 | P5 | P6 | P7 | P8 | P9 |
| Wa | 0.6 | 0.4 | 0.3 | 1.6 | 2.9 | 9.1 | 10.4 | 0.1 | 2.1 |
| Wb | 0.5 | 0.9 | 0.3 | 2.8 | 3.9 | 14.5 | 21 | 0.3 | 6.8 |
| We | 0.4 | 0.3 | 0.6 | 14.6 | 2.0 | 6.4 | 12.6 | 2.7 | 2.5 |
| Wd | 0.7 | 0.2 | 3.6 | 11.7 | 3.6 | 4.2 | 13.5 | 12.7 | 3.5 |
| We | 0.2 | 1.1 | 2.0 | 6.2 | 10.1 | 3.5 | 4.6 | 10.4 | 1.5 |
| SW | 0.3 | 0.5 | 0.2 | 2.7 | 2.7 | 15.8 | 13.5 | 2.9 | 5.2 |
| LW | 0.2 | 0.1 | 0.8 | 6.7 | 1.2 | 2.0 | 5.2 | 0.2 | 0.9 |
| Glanz | 97 | 82 | 86 | 46 | 81 | 78 | 85 | 78 | 75 |
| Haze | 0 | 3 | 8 | 19 | 28 | 25 | 20 | 90 | 26 |

Wa to We: wavelength ranges according to table 1, measured using measuring device Wave Scan Plus by Byk Gardner
LW: long wave, measured using measuring device Wave Scan Plus by Byk Gardner
SW: shortwave, measured using measuring device Wave Scan Plus by Byk Gardner
Gloss in GLE (gloss units) according to ONORM EN ISO 2813; as of 1999 Jun. 1: “Coating materials - Determination of the reflectometer value of coatings at 20°, 60° and 85°”, measuring device: Haze Gloss by Byk Gardner, observation angle of 20°
Haze: measured according to ISO 13803 (as of 2004 Sep. 1: “Coating materials - Determination of the haze of coatings at 20°, measuring device: Haze Gloss by Byk Gardner
PMMA-ABS: co-extruded PMMA-ABS multi-layered composite, type Senosan ® AM1500X, thickness 0.7 mm

For this reason, there has been developed an application system, in which the solvent-free UV-curing surface-coating system is applied to an, in the surface optically flawless, transfer medium having a thickness of up to 1600 mm and being transparent for UV light. This surface-coated, UV-transparent and optically flawless transfer medium is then pressed onto the substrate (the co-extruded composite body) at a certain contact pressure and immediately afterwards cross-linked using UV lamps, so that the surface-coating material then cures into the direction of the cover layer. UV irradiation is realized through the UV-transparent, optically flawless transfer medium. In the process, the UV-transparent and optically flawless transfer medium remains in close contact with the solvent-free UV-curing surface-coating system. By this contact pressing of the solvent-free, UV-curing surface-coating system by means of the UV-transparent, optically flawless transfer medium onto the substrate layer with simultaneous UV-curing, the surface quality of the future UV-surface-coated substrate is defined by the optically flawless surface quality of the transfer medium.

The first UV irradiation may thereby still be realized during the contract-pressing process of the surface-coated, UV-transparent medium onto the substrate. There is, however, also given the possibility to realize a second UV irradiation for post-cross-linking, wherein in this case the post-UV-irradiation is realized either again through the UV-transparent, optically flawless transfer medium or after removal of the UV-transparent, optically flawless transfer medium directly onto the pre-cured surface-coated layer. Due to the mutual embedding of the UV-curing surface-coating system during the phase of cross-linking there is given the advantage that there do not occur virtually any parallel reactions, such as, e.g., with the oxygen of the air, which is why there is given a very high cross-linking density of the cured cover layer. It has surprisingly been shown that the optical surface structures, which the UV-transparent, optically flawless transfer medium has, transfer onto the surface-coated surface following the curing step in a nearly identical way, so that the optical characteristics (gloss and haze) according to the claims may then be defined as optically flawless surface of the transfer medium.

There is made the provision that the U V-transparent, optically flawless transfer medium is peeled off after the cover layer (1) has been cured. It may, however, also remain as a protection of the surface. If the UV-transparent, optically flawless transfer medium is peeled off, however, then there is the possibility to apply a protective film onto the cross-linked surface-coated layer in order to protect the surface for the transport process as well as further processing. Protective films of this type usually are composed of polyethylene; they may have an adhesive layer on their rear side.

Characterization of the Mechanical Durability of the Surface

The characterization of the surface is performed according to company standard IDH-W-466 “Determination of the resistance to micro-scratches with furniture films” (“Bestimmung der Bestandigkeit gegen Mikrokratzer bei Mobelfolien”) of the Institut fiir Holztechnologie Dresden gemeinnUtzige GmbH as of 2010 Dec. 20. This company standard is just about to be authorized as official standard and is based on the prEN 160945:2010; as of: 2010 May 15 “Laminate floor coverings—Test method for the determination of micro-scratch resistance” (“Laminatboden—PrUfverfahren zur Bestimmung der Mikrokratzbestandigkeit”) having slightly changed parameters according to method A. As a test device, there is used a Martindale abrasion test device. The individual test bodies are conditioned before being treated according to standard prEN 16094:2010, and the gloss is measured. Afterwards, the samples are each stressed with 80 abrasion cycles, wherein there is used for every single sample a new Scotch Brite Ultra Fine Hand Pad 7448. This Scotch Brite abrasion material is a fibre-fleece hand pad having an abrasion grain type CF S—silicon carbide (hard and pointed). Fineness is S ultra fine (FEPA grain size 500-600), colour gray. In the prEN 16094:2010 there is proposed a Scotch Brite abrasion material type 7447 (a fibre-fleece hand pad having abrasion grains type CF material with aluminium oxide abrasion grains) (type A, abrasion grains having high toughness) having a fineness grade A very fine FEPA grain size 320 to 360. The applied test force is 6N.

Measurement of gloss is realized 24 hours after test using a measuring device: Haze Gloss by Byk Gardner, observation angle: 200 according to ONORM EN ISO 2813; as of 1999-0601: “Coating materials—Determination of the reflectometer value of coatings at 20°, 60° and 85°” (“Beschichtungsstoffe—Bestimmung des Reflektometerwertes von Beschichtungen unter 20°, 60° and 85°).

The evaluation of the test was realized according to the method described in the prEN 16094: 2010 in 8.2.1 Method A; and the mean value of the gloss change is indicated. The results are summarized in the following table 3:

TABLE 3
Results of the tests regarding micro-scratch
resistance according to prEN 16094: 2010

| | Determined reflectometer value at a geometry of 20° [gle] | | |
|---|---|---|---|
| | | After 80 abrasion | |
| Sample | Original state | cycles | Gloss change in % |
| 1 | 83.4 | 67.3 | 19.3 |
| 2 | 92.2 | 90.1 | 2.3 |
| 3 | 80.5 | 71.0 | 11.8 |
| 4 | 97 | 96.5 | 0.5 |
| 5 | 80 | 0.6 | 99.3 |

Sample 1: furniture film, commercially available, substrate polyester, coated with solvent-based, UV-cured surface-coating material
Sample 2: inventive configuration, substrate Senosan ® AM1500X, coated with solvent-free, UV-cured surface-coating material
Sample 3: inventive configuration, substrate Senosan ® A45, coated with solvent-UV-cured surface-coating material
Sample 4: glass, commercially available, for use as furniture front
Sample 5: Senosan ® AM1500X, not coated. This is a co-extrudate of a cover layer made of PMMA with a substrate made of ABS

As can be seen from table 3, the inventive configurations 2 and 3 show significantly better qualities than the commercially available films and thus rather are very close to those of glass.

Characterization of the Chemical Durability of the Surface

An assessment method for the classification of the durability of furniture films with regard to liquids is given by the DIN EN 12720:2009: “Furniture—Assessment of surface resistance to cold liquids” (“Mobel—Bewertung der Bestandigkeit von Oberflachen gegen kalte Fltissigkeiten”), as of July 2009. From the test liquids indicated in the assessment methods, acetone is used as medium for the tests. The composites are pre-conditioned according to 6.1 of the DIN EN 12720:2009 and then tested, which is why the tests regarding the subject requirements should also be carried out under these conditions. Also, for tests there are to be selected the testing times defined in table 1 under point 7.2 of the DIN EN 12720:2009 as well as the evaluation method according to 9.

TABLE 3
Test results regarding the test of resistance of furniture
films to liquids according to DIN EN 12720: 2009

| | Sample 1 | Sample 2 | Sample 3 | Sample 4 |
|---|---|---|---|---|
| Medium | acetone | acetone | acetone | acetone |
| Testing time | 1 h | 1 h | 1 h | 1 h |
| Grading | 5 | 1 | 5 | 1 |

Sample 1: glass, which is used for the production of furniture fronts
Sample 2: PMMA-ABS co-extrudate; Senosan ® AM1500X. This is a co-extrudate of a cover layer made of PMMA with a substrate made of ABS.
Sample 3: configuration according to the invention
Sample 4: commercially available furniture film, substrate polyester, coated with solvent-based, UV-cured surface-coating material

Composite bodies, which essentially only extend in a two-dimensional way, are formed by thermoforming into three-dimensional components. For such bending, there is required a bending device adapted for the composite body. The bending process in the bending direction is a defined process course regarding the introduction of the required temperature or heat, respectively, into the composite body. If the composite body has a coating, e.g., of an UV-cured cover layer, then there is given the danger that the coating will break in certain areas due to stretching, which will inevitably occur with bending.

So far, there has always been ensured that the mechanical and thermal bending conditions are carefully fulfilled with regard to the materials of the composite body and the cover layer in the area of the bending zone. An important aspect is the manner how the necessary heat is introduced in the bending area. After the area to be bent has been heated, the composite body may be bent. Thereby, there has to be considered in prior art that the form parts for the bending tool will cause deformations in the softened surface of the composite body.

It is thus the task of the present invention to provide, apart from the provision of a composite body, also a bending method as well as a bending device and a forming shoe for a bending device, which make it possible to bend a coated composite body, without cracks being formed in the coating or mechanical tensions being developed in the surface of the composite body.

This task is solved by a bending device for a composite body—in particular of the type mentioned above—including a conveying device for the composite body and at least one heating device for heating the area of the composite body to be bent, characterized by a forming shoe extending along the conveying direction, wherein the forming shoe has a bending edge, the inclination of which increases with regard to the conveying plane of the conveying device increases along the conveying direction.

There is preferably provided that the inclination of the bending edge increases steadily from about 0° to the desired angle of inclination, preferably 90°, with regard to the conveying plane.

In one embodiment variant there is provided a heating device for the forming shoe, preferably for the bending edge. After heating it should be avoided that the composite sheet cools too quickly during the forming process, this is, during the bending process energy is to be introduced additionally in order to prevent surface cracks. The heating devices are preferably hot air heaters. The area to be bent may be heated using the nozzles of the air heater. The minimum of the energy required is introduced in the minimum of the softening zone required. By means of a nozzle form adapted to the bending process, the air jet may be guided into the immediate vicinity of the area to be bent. Such an air heater makes it possible to introduce the necessary energy in the area underneath the forming shoe to a certain extent and thus balance the cooling of the area to be bent during bending.

There may be, for instance, provided that the conveying device has a roller table.

There may be further provided a temperature measuring device, which is arranged so that the temperature of the area of the composite body to be bent may be determined. There is preferably provided that the temperature measuring device includes a pyrometer. The temperature measuring device measures the surface temperature and is preferably connected with control logic. In this way, a continuous heating quality and thus an appropriate temperature level may be reached or maintained, respectively.

In one embodiment variant there is provided a control system, which controls the heating device for the forming shoe in dependence on the temperature determined. Using the control, the measurement values may be read from the temperature measuring device within the shortest of time (0.1 seconds), and new nominal values may be provided to the heating device.

The forming shoe that is exactly adapted to the composite body to be bent makes it possible to bring the heated composite sheet into the desired form in a rather gentle way. The forming shoe is configured so that the deflection of the sheet to be bent is realized gently. Using the heating device with the adapted nozzles, the bending zone of the area to be bent may be post-heated during the bending process. The forming shoe may further have channels which may be supplied with a temperature controlling liquid, so that there is given the possibility to additionally perform temperature control of the forming shoe.

The design of the forming shoe has a further forming area for levelling the surface. Any corrugations in the composite body, which are caused by heating, are then introduced in the forming area for levelling. In this way, the corrugations may be levelled or minimized, respectively. At the same time, the composite body may be formed and contact-pressed onto the carrier material following the bending process of the composite body.

Inline Bending Method:

Based on the bending method known, wherein a carrier material is required, this described method may be transformed into an inline bending method. In standard operation, the composite body is coated onto a carrier material and processed there (post-forming), and the necessary bending is realized. If this carrier sheet, e.g. made from wood, is then removed and replaced by an exchangeable stable form sheet in the installation, the composite body may then be fed as a sheet form or moved by the roller through the installation. The result is a bent product, which has been bent practically without any carrier material. Only the composite body has to be pushed through the installation. In inter-action with forming sheet and forming shoe, the generation of the desired bending form is then realized. After the bending process, the parts may then be appropriately dimensioned and provided for further processing.

Method for the Production of a Substrate

A substrate is a two-dimensional multi-layered composite body, which includes at least the second intermediate layer (3-1) and the substrate layer (3). It is produced in the extrusion or co-extrusion method. The at least two-layered composite bodies according to the invention may be produced in a single-step method by means of adapter or nozzle co-extrusion. Thereby, the materials of the different layers are made flowable each in an extruder by thermal effects and are then combined in an adapter system or a multi-channel nozzle or a combination of both into said multi-layered substrate and ejected by the nozzle, fed over a polishing calendar and cooled. Cooling is usually effected by the semi-finished products being fed via a cooling track.

Cover Layer (1)

The cover layer is composed of a surface-coating layer, polymerized by means of UV irradiation. Ultraviolet radiation, in brief ultraviolet or UV radiation, is electromagnetic radiation that is invisible for human beings and has a wavelength that is shorter than that of the light visible for human beings but longer than that of X-rays. This range is situated between 1 nm and 380 nm. The surface-coating layer is produced by applying and curing the surface-coating material according to the inventive method onto the substrate in order to represent the composite body according to the invention. In contrast to oil, dispersion and 2-component surface-coating materials, however, 100% surface-coating UV materials do not have any volatile ingredients. Neither water nor solvents are contained therein. After curing, UV-cured surface-coating materials, hence, are composed of virtually 100% solids, as they will cure due to UV irradiation, without losing essentially any mass weight. Apart from reactive moieties such as, e.g., acrylates (non-saturated polymers of the acrylic acid) these may include reactive diluents, photoinitiators, pigments, dyes, effect pigments and other additives. By using UV additives (UV absorbers and UV stabilizers) to an extent of 0.01 to 5% by weight, the materials and colorants used in the layers lying underneath will be protected against UV radiation, which is why colour retention as well as continuous material characteristics will be significantly improved over the time of use when irradiated with UV light. Furthermore, the cover layer or the surface-coating UV material, respectively, may be transparent or embodied with different colorants, respectively. In the surface-coating layer, there may also be included nanoparticles in order to improve various characteristics. The cover layer is applied onto the optional upper intermediate layer (2) or onto the lower intermediate layer (3-1) in the method according to the invention.

Optional Upper Intermediate Layer (2)

The optional upper intermediate layer (2) between the substrate layer (3) and the cover layer (1) is composed of—if it is existent at all—preferably polymethyl methacrylate (PMMA), impact-modified PMMA/HI-PMMA or a blend thereof. The optional intermediate layer (2) may be used if the substrate layer is composed of acrylonitrile-butadiene-styrene terpolymer (ABS), impact-modified polystyrene (PS), acrylonitrile-styrene-acrylic ester (ASA) or styrene co-polymers. The most important characteristics of PMMA are summarized in Hans Domininghaus, “Die Kunststoffe and ihre Eigenschaften”, edition 1998, p. 455-481. PMMA is extremely suitable as an intermediate layer material, as it shows high hardness and scratch resistance and is transparent. The increased hardness, in this connection, is advantageous as the cover layer (1) situated above is very thin but prevents, however, in combination with the hard upper intermediate layer (2) impressions in the case of pres sure-like strain.

A high transparency of the upper intermediate layer (2) is advantageous as the combination of the transparent surface-coating cover material and the transparent intermediate layer (2) situated underneath and having the coloured substrate layer (3) will result in increased spatial perception, similar to that of back-coated glass.

In the range of visible light (380 nm to 780 nm) the spectral transmission of the thermoplastic material is in one embodiment variant at least 80% (preferably at least 85%), measured using colourless sample bodies according to ISO 13468-2 (as of: 1999) at the layer thickness selected for the composite body. It is only natural that the thermoplastic material may also be a blend of plastic materials. In the case that the thermoplastic material is a plastic blend, this plastic bland should have a spectral transmission in the entire wavelength range from 380 nm to 780 nm of at least 80%, measured using sample bodies according to ISO 13468-2 (as of 1999).

There may also be added colorants to the upper intermediate layer (2). It may further be necessary to add UV additives. The upper intermediate layer (2) is applied onto the lower intermediate layer (3-1) in the co-extrusion method.

Lower Intermediate Layer (3-1)

The lower intermediate layer (3-1) includes a thermoplastic polymer, and it may include, e.g., the same polymer as the substrate layer. In this case, there is to be noted, for example, acrylonitrile-butadiene-styrene terpolymers (ABS). In one embodiment variant there is provided that the lower intermediate layer (3-1) includes glycol-modified polyethylene terephthalate (PETG).

If PETG is used as a material for the further intermediate layer (3-1), then this may realized by colouring with colorants; the layer, however, may also be non-coloured. There may optionally be added UV additives. The lower intermediate layer (3-1), however, does not contain preferably any grinding material, recyclate or regenerate. As the substrate layer (3) constitutes the colour-bestowing layer and as the requirements of the furniture industry regarding colour consistency are rather increased, and as it is significantly more difficult to retain colour tolerance due to the addition of grinding material, recyclate or regenerate, the lower intermediate layer (3-1) serves to achieve the highest colour consistency possible. Therefore, in the lower intermediate layer (3-1) polymers are coloured analogously to the substrate layer (3), using appropriate colorants. It may further be required to add UV additives.

The essentially more voluminous substrate layer (3) thereby may be coloured using essentially lower concentrations or with less cost-intensive colorants than the lower intermediate layer (3-1). For this reason, there may also be used very expensive colouring materials, as the concentration thereof with regard to the overall thickness of the co-extruded composite body is a rather lower one.

Substrate Layer (3)

The substrate layer (3) presents the largest percentage of the multi-layered composite. There are used thermoplastic polymers as materials. In the framework of the invention, a thermoplastic material is a plastic material, which may be deformed in a thermoplastic way within a certain temperature range. The thermoplastic formability is a reversible process so that the thermoplastic material may be brought into the formable state repeatedly by cooling and heating. Pure plastics (homopolymers, hetero- or co-polymers, respectively) and plastic blends (mixtures of different plastic materials) are summarized as thermoplastic materials.

Preferably there may be used acrylonitrile-butadiene-styrene terpolymers (ABS), impact-modified polystyrene (PS), acrylonitrile-styrene-acrylic ester (ASA), styrene co-polymers, polyolefins such as polypropylene or polyethylene, polycarbonate, polyethylene terephthalate (PET) or modified co-polymers such as glycol-modified polyethylene terephthalate PETG).

There may further be present a blend of plastics as a thermoplastic material, or it may be necessary, respectively, to add additional materials in order to achieve the desired characteristics. In any case, however, the thermoplast used is essentially free of PVC.

The substrate layer may optionally include grinding material, recyclate or regenerate (e.g., of preceding production steps or the installation of the extrusion plant or edge trimming). There may be added colorants to the substrate layer (3); and it is necessary to combine colorants of most diverse types in order to adapt to the colour tones wished by the customers. It may be further required to add UV additives.

If the substrate layer is not configured in a mono-layered but rather in a multi-layered way, the embodiment is then configured so that there may be arranged a lower intermediate layer (3-1) between the cover layer (1) or the intermediate layer (2) and the substrate layer (3). This is preferably composed of the same polymer as the substrate layer (3), in particular in the case ABS. If polyethylene terephthalate (PET) or modified co-polymers such as glycol-modified polyethylene terephthalate (PETG) is used as a material, then there is preferably used glycol-modified polyethylene terephthalate (PETG) in the lower intermediate layer (31).

Rear Cover (3-2)

At the side opposite to the cover layer (1) of the multi-layered composite according to the invention, there may be arranged a further optional rear-sided cover layer (rear cover) (3-2). This is essentially composed of the thermoplastic material, as described in the substrate layer (3); there is, however, herein also not added any grinding material, recyclate or regenerate: If the substrate layer (3) includes polyethylene terephthalate (PET) or modified copolymers such as glycol-modified polyethylene terephthalate (PETG), then the rear cover (3-2) is preferably and essentially composed of glycol-modified polyethylene terephthalate (PETG).

Regardless of the raw materials, which are used in the rear cover (3-2), there may be added matting agents. Matting agents are in general additives, which have such effects on the surface of a coating so that the gloss grade thereof will decrease. There is usually associated therewith an increase of surface roughness, which will show an improved processing performance in the process about to follow, this is, lamination. Suitable matting agents are known to those skilled in the art and include, e.g., inorganic fillers, in particular silica gel or cross-linked polymers in bead form (“polymer beads”), preferably acrylate beads. The amount added is preferably between 0.1 and 5% by weight.

If the rear cover (3-2) is composed of polymer blends, then there may also be generated a matted rear-side cover layer due to the morphology existent in the polymer alloy, which has the same positive effect on further processing as the addition of a matting agent. For this reason, an additional matting agent may be omitted in this configuration.

If the adhesion of the multi-layered composite according to the invention having the adhesion promoter/primer layer (4) is insufficient, then there could be added chemical adhesion promoters to the rear cover (3-2). This is especially used with substrate layers on the basis of polyolefins: examples thereof are ethylene-vinyl acetate co-polymers in the case of polyethylene, or maleic anhydride-grafted polypropylenes in the case of polypropylene. In both cases the polarity of the surface is increased by the co-monomers added, resulting in improved adhesion performance.

The optional rear cover (3-2) may be coloured by colorants, there is, however, also the possibility of not colouring this layer. There is further the possibility to add antistatic additives (also known as antistatic agents) to the optional rear cover (3-2). “Antistatic agents” is the tem’ for substances, which, when added as additives, prevent or weaken, respectively, the static charge of articles. Antistatic agents are used in order to prevent the undesired effects of electrostatic charges, caused by mechanical friction. Hence, electrostatic charge may lead to undesired effects of attraction or repulsion or to sudden electrical discharges. Specific examples thereof would be the prevention of dust attraction, hair “standing straight out” or ignition of explosive mixtures by discharge sparks. Especially materials having a high electric resistance, such as, e.g., thermoplastic materials, are affected by this phenomenon and thus have to be provided with antistatic features.

It has been shown that furniture films, which are provided with additives of this type, become less statically charged and thus attract dust in an essentially lower amount. Dust on furniture films is enclosed during the lamination process between films and MDF (medium-density fibreboards) and leads to unattractive defects (waviness) on the finished furniture panel. According to the invention, all types of antistatic agents, which essentially prevent the attraction of dust in processing, may be added.

Also herein, there is being made use of the advantages of co-extrusion: The essentially more voluminous substrate layer (3) need not be provided with the additives or colorants, which are used in the optional rear cover (3-2). For this reason, also expensive additives or colorants may be used, as the concentration thereof with regard to the overall thickness of the co-extruded composite body is very low.

Adhesion Promoter/Primer Layer (4)

On the rear side of the substrate layer (3) or of the rear cover (3-2) there is optionally applied an adhesion promoter layer (4). Therefore, the surface is subjected to surface pre-treatment by activation before the primer layer will be applied. This is realized, e.g., by corona treatment, flame treatment, plasma treatment or fluorination. The primer/adhesion promoter is then applied onto this activated surface. A primer layer is understood in general as a paint coating or coating for improving the adhesion of adhesive layers. In the case of furniture films it serves to improve the adhesion to the wood plate, which is usually composed of MDF (medium-density fibreboards).

Colorants

Pigments, dyes or effect pigments are designated as colorants. The combination of colorants of the most varied types is necessary in order to adjust the colour tones desired by the customers.

In contrast to dyes, pigments are insoluble in the carrier medium. The term “carrier medium” designates the material, into which the pigment is introduced, e.g., a surface-coating material or a plastic material. Dyes and pigments belong to the group of colorants and may be inorganic or organic, coloured or non-coloured.

According to literature, Gunter Buxbaum, “Industrial Inorganic Pigments”, edition 1993, page 207-224, effect pigments, as used in the lower intermediate layer (3-1), may be distinguished into two large classes, pearlescent pigments and metallic effect pigments. Pigments of this type may be used to achieve special visual effects; they may also be used in combination with normal pigments and/or dyes.

UV Additives

The ultraviolet proportion of the sun light destroys chemical bonds in some polymers in a process called photodegradation. This will cause, due to chemical changes in the polymer, also changes in the chemical and physical performance. Cracks, discolouration, colour changes, e.g., are consequences and results of these reactions. In order to prevent or delay effects of this type, there may be added UV additives. Dependent on the mode of action of these UV additives, there is distinguished between UV absorbers and UV stabilizers. UV absorbers lead to an absorption of UV radiation, which moves through the polymer, and convert this to thermal energy. As an example of very effective absorbers, there are to be mentioned benzophenons. UV stabilizers inhibit free radicals, which are developed by the irradiation with UV radiation, and stop further degradation. As an example of very effective stabilizers, there are to be mentioned HALS (hindered amine light stabilizers).

### Exemplary Embodiments

The invention is in the following explained by way of examples. To this end, the materials, which were among others thermoplastic, were manufactured in the co-extrusion method having a width of 1300 mm, and in the consequence, using the method according to the invention, composite bodies according to the invention were produced.

### Example 1

Cover layer (1): 11 μm UV-cured surface-coating material

Optional intermediate layer (2): 0.024 mm Altuglas V046 glass-clear PMMA

Intermediate layer (3-1): 0.059 mm Styron Magnum 3404 Natur ABS+colour

Substrate layer (3): 0.480 mm Styron Magnum 3404 Natur ABS+colour+20% accrued grinding material

Optional rear-side cover layer (3-2): 0.031 mm 85% Styron Magnum 3404 Natur ABS+15% Styron Magnum XZ96515 ABS matt

### Example 2

Cover layer (1): 11 vim UV-cured surface-coating material

Intermediate layer (3-1): 0.061 mm Styron Magnum 3404 Natur ABS+colour

Substrate layer (3): 0.299 mm Styron Magnum 3404 Natur ABS+colour+20% accrued grinding material

Optional rear-side cover layer (3-2): 0.030 mm 85% Styron Magnum 3404 Natur ABS+15% Styron Magnum XZ96515 ABS matt

### Example 3

Cover layer (1): 6 m UV-cured surface-coating material

Optional intermediate layer (2): 0.024 mm Altuglas V046 glass-clear PMMA

Intermediate layer (3-1): 0.061 mm Styron Magnum 3404 Natur ABS+colour

Substrate layer (3): 0.380 mm Styron Magnum 3404 Natur ABS+colour+30% accrued grinding material

Optional rear-side cover layer (3-2): 0.029 mm 85% Styron Magnum 3404 Natur ABS+15% Styron Magnum XZ96515 ABS matt

Characterization of the UV-Cured Surface-Coating Material Used:

It includes, among others, 1,6-hexanediol diacrylate as well as trimethoxyvinyl silane, in small amounts triphenyl phosphite. Density is indicated with 1.14 g/ml having an output viscosity of 0.15-0.25 Pas at 25° C., measured using a rotation viscosimeter according to DIN 53019/ISO3219, as of 1994.

From the tests of the examples 1 to 3, there may be derived the following results:

TABLE 4
results of the tests for examples 1-3.

| | Thickness | | Resistance | | | | |
|---|---|---|---|---|---|---|---|
| | surface-coating | Micro-scratch | to chemical | | | | |
| | layer ¹⁾ | resistance ²⁾ | agents ³⁾ | Gloss ⁴⁾ | Haze ⁵⁾ | LW ⁶⁾ | SW ⁷⁾ |
| Example 1 | 11 | 3.9 | 5 | 87.4 | 9.8 | 0.8 | 0.2 |
| Example 2 | 11 | 6.5 | 5 | 88.2 | 5.7 | 0.9 | 0.4 |
| Example 3 | 6 | 15.9 | 5 | 86.3 | 14.3 | 1.0 | 0.3 |

¹⁾ Thickness of the surface-coating layer: [= 1.tm, measured using microscope Nikon Eclipse ME600, on thin-sections
²⁾ [ ] = % micro-scratch resistance, measured following prEN 16094 as of 2010 May 15: “Laminate floor coverings - Test method for the determination of micro-scratch resistance”, characterized by the loss of gloss at 20° before strain minus gloss at 20° after strain, indicated in percent
³⁾ Resistance to chemical agents, measured according to DIN EN 12720 as of July 2009:
“Furniture - Assessment of surface resistance to cold liquids” using acetone as a test liquid for a test duration of 1 h
⁴⁾ Gloss in GLE (gloss units) according to ( )NORM EN ISO 2813, as of 199-06-01: “Coatings - Determination of the reflectometer value of coatings at 20°, 60° and 85°”, measuring device: Haze Gloss by Byk Gardner, angle of observation: 20°
⁵⁾ Haze: according to ONORM EN ISO 13803, as of 2004 Sep. 1: Coatings - Determination of the haze of coatings at 20°, measuring device: Haze Gloss by Byk Gardner
⁶⁾ LW: Long wave, measured using measuring device Wave Scan Plus by Byk Gardner
⁷⁾ SW: Short wave, measured using measuring device Wave Scan Plus by Byk Gardner

Bending Device:

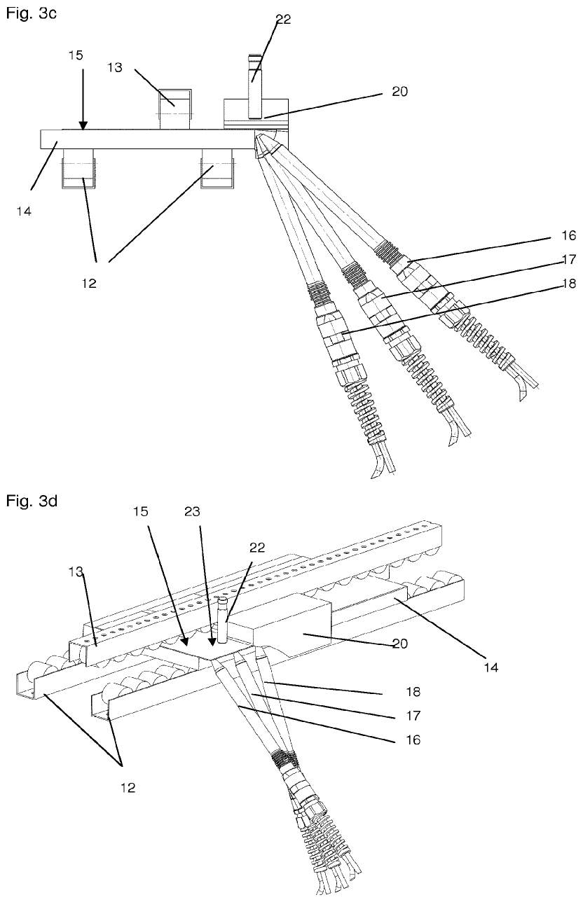

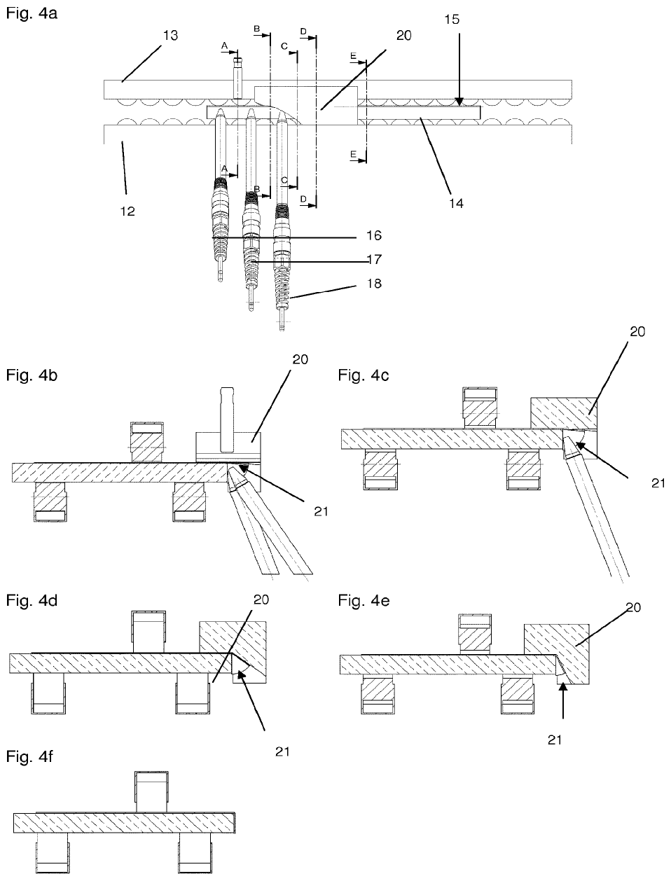

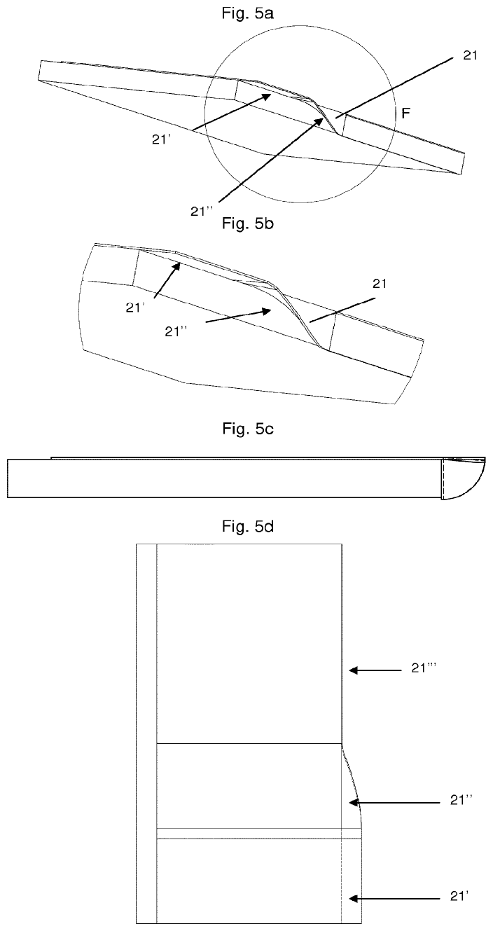

The FIGS. 3a to 4f show a bending device 11 according to the invention for a composite body of the type mentioned above. The FIGS. 5a to 5d show the associated forming shoe 20. The FIGS. 3a to 5d are in the following described together, as they each show one embodiment example in different views. The bending device 11 has a conveying device 12, 13 for the composite body 15 and is composed of a roller table 12 and a roller beam 13, between which there is conveyed a wooden plate 14 having a composite body 15 arranged on the surface thereof. In total three heating devices 16, 17, 18 are responsible for heating the area 23 of the composite body 15 to be bent. The forming shoe 20 is extended along the conveying device 12, 13 of the composite body 15, wherein the forming shoe 20 has a bending edge 21, the inclination of which increases with regard to the conveying plane E of the conveying device 12, 13 along the conveying direction. The bending edge 21 is clearly recognizable in the FIGS. 5a to 5d, in particular in the detailed view F (FIG. 5b). Therein is shown the first area of the bending edge 21′, in which the inclination with regard to the conveying plane E of the conveying device 12, 13 is 0°. The inclination will constantly increase in the conveying direction, wherein the bending edge 21 is adjusted to the desired angle of inclination from here 90° in the area 21′″. In the area 21″, the bending edge 21 is curvilinear and forms a transition from the inclination of 0° to the desired inclination.

In the FIGS. 4b to 4f, the forming shoe 20 is visible in practical use at various positions. The composite sheet 15 protrudes beyond the edge of the wooden plate 14 by the area 23 to be bent. At the beginning of the bending device 11, the area 23 to be bent is only heated. The forming shoe 20 with the bending edge 21 is situated in parallel to the composite sheet 15 (FIG. 4b). With increasing bending (FIGS. 4c, 4d, 4e), the angle of inclination of the area 23 to be bent will become larger with regard to the conveying plane E by the guiding of the bending edge 21 or also with regard to the plane of the composite sheet, respectively. At the end of the bending edge 21 (FIG. 4f), the area 23 to be bent is completely bent (herein about 90°) and is flush with the lateral front edge of the wooden plate 14.

The heating devices 16, 17, 18 provide for the heating of the composite sheet 15, wherein the heating device 18 has already been assigned to the forming shoe 20. After heating, it should be avoided that the composite sheet 15 cools too quickly during the forming process, this is before and during the bending process energy is to be introduced in order to prevent surface cracks. The heating devices 16, 17, 18 are hot air heaters. The area 23 to be bent may be heated using the nozzles of the air heater.

There is further provided a temperature measuring device 22, which is arranged so that the temperature of the area of the composite body to be bent may be determined. The temperature measuring device 22 includes a pyrometer. Therewith, the surface temperature of the composite body is measured. A control device that is not shown is connected with the heating device 16, 17, 18 for the forming shoe 20 and controls this in dependency on the temperature determined by the temperature measuring device 22. If the temperature is too low, there may be additionally heated.

The forming shoe 20 further has a levelling area 24, which serves to level any unevenness or waviness of the composite body.

1-23. (canceled)

24: A method of making a composite body, said composite body comprising in the following order:
a UV-cured cover layer forming a top surface and having a layer thickness of 1-20 μm,
an intermediate layer, containing colorants,
a substrate layer, containing a thermoplastic polymer or a blend of thermoplastic polymers and colorants,
wherein the top surface has the following properties:
a) a gloss loss of at most 30% following a micro-scratch resistance test measured following prEN 16094 (as of 2010 May 15: “Laminate floor coverings—Test method for the determination of micro-scratch resistance”);
b) a numerical assessment of ≥3, in a chemical resistance test measured according to DIN EN 12720 (as of July 2009: “Furniture—Assessment of surface resistance to cold liquids”) using acetone as a test liquid for a test duration of 1 h;
c) a gloss of at least 80 measured according to ISO 2813 (as of 1999 Jun. 1: “Coating materials—Determination of the reflectometer value of coatings at 20°, 60° and 85°”) at an observation angle of 20°; and
d) a haze of at most 20 measured according to ISO 13803 (as of 2004 Sep. 1: “Coating materials—Determination of the haze of coatings at 20°”),
the method of making the composite body comprising the steps of:
providing a composite body having a substrate layer, and an intermediate layer,
applying a UV-curing surface-coating material onto said intermediate layer by applying a solvent-free UV-curing surface-coating material to a UV-transparent transfer medium and pressing the UV-transparent transfer-medium having the UV-curing surface-coating material applied thereto onto the intermediate layer, and
curing the UV surface-coating material by exposing the UV-curing surface-coating material to UV radiation which UV-radiation passes through the UV-transparent transfer medium.

25: A method of making a composite body according to claim 24, wherein the UV surface-coating material is simultaneously pressed into the intermediate layer while the UV irradiation is being applied.

26: A method of making a composite body according to claim 24, wherein UV irradiation is applied in several steps, wherein at least during a first step irradiation is applied through the UV-transparent transfer medium.

27: A method of making a composite body according to claim 24, wherein a protective layer is applied to the UV-cured cover layer following curing of the UV surface-coating material.

28: A method of making a composite body according to claim 24, wherein the substrate layer contains grinding material, recyclate or regenerate.

29: A method of making a composite body according to claim 24, wherein the composite body further comprises at least one of a rear cover and an adhesion promoter layer arranged underneath said substrate layer.

30: A method of making a composite body according to claim 24, wherein the gloss loss of the surface is at most 20% following a micro-scratch resistance test measured following prEN 16094 (as of 2010 May 15: “Laminate floor coverings—Test method for the determination of micro-scratch resistance”).

31: A method of making a composite body according to claim 24, wherein the gloss of the surface is least 85 GLE measured according to ISO 2813 (as of 1999 Jun. 1: “Coating materials—Determination of the reflectometer value of coatings at 20°, 60° and 85°”) at an observation angle of 20°.

32: A method of making a composite body according to claim 24, wherein the haze of the surface is at most 15 measured according to ISO 13803 (as of 2004 Sep. 1: “Coating materials—Determination of the haze of coatings at 20°”).

33: A method of making a composite body according to claim 24, wherein the upper intermediate layer essentially consists of polymethyl methacrylate, impact-resistant-modified polymethyl methacrylate or a blend of both.

34: A method of making a composite body according to claim 24, wherein the substrate layer includes ABS or PET.

35: A method of making a composite body according to claim 24, wherein the intermediate layer includes a same polymer as the substrate layer.

36: A method of making a composite body according to claim 24, wherein the intermediate layer includes glycol-modified polyethylene terephthalate, and the substrate layer contains polyethylene terephthalate or glycol-modified polyethylene terephthalate and the rear cover contains glycol-modified polyethylene terephthalate.

37: A method of making a composite body according to claim 24, wherein the cover layer comprises 0.01 to 5% per weight of UV additives.

38: A method of making a composite body according to claim 24, wherein the composite body further comprises another intermediate over said intermediate layer, said another intermediate layer comprising 0.01 to 5% per weight of UV additives.

39: A method of making a composite body according to claim 24, wherein at least one of the cover layer, the rear cover, and the intermediate layer comprises colorants.

40: A method of making a composite body according to claim 24, wherein the composite body further comprises another intermediate over said intermediate layer and said another intermediate layer comprises colorants.

41: A method of making a composite body according to claim 28, wherein the composite body further comprises another intermediate over said intermediate layer, said another intermediate layer having in the layer thickness for the composite body over the entire wavelength range from 380 nm to 780 nm a spectral transmission of at least 80% measured with non-coloured test bodies according to ISO 13468-2 (as of 1999).

42: A method of making a composite body according to claim 24, wherein the rear cover comprises additives, selected from the group consisting of matting agents, adhesion promoters, antistatic agents, or mixtures thereof.

43: A method of making a composite body according to claim 24, wherein said intermediate layer further includes additives for improving UV resistance.

44: A method of making a composite body according to claim 24, wherein the composite body further comprises another intermediate over said intermediate layer.
